(19) United States
(12) Patent Application Publication
(10) Pub. No.: US 2026/0065377 A1
(43) Pub. Date: Mar. 5, 2026

(54) SYSTEMS AND METHODS FOR ISSUANCE AND USE OF PRIVATE EQUITY TOKENS

(71) Applicant: JPMORGAN CHASE BANK, N.A., New York, NY (US)

(72) Inventors: Dennis CRISTALLO, New York, NY (US); Kirsten JONES, Southbourne (GB); Nicholas WHITAKER, Plandome Heights, NY (US); Chang Yang JIAO, New York, NY (US); Manmeet AHLUWALIA, Tampa, FL (US); Keerthi MOUDGAL, Brooklyn, NY (US)

(21) Appl. No.: 18/824,330

(22) Filed: Sep. 4, 2024

(51) Int. Cl. G06Q 40/12; G06Q 40/06

(52) U.S. Cl. CPC G06Q 40/12; G06Q 40/06; G06Q 2220/00

(57) ABSTRACT

A method may include: receiving capital needs from a fund manager; retrieving an amount committed, an amount called, an amount unfunded, and an amount distributed for investors from an investor register on a digital assets blockchain; establishing investor level capital call details; minting a total fund token balance to a blockchain address for the fund manager; enriching the investor level capital call details; sharing, the enriched investor level capital call details with the distributor; moving funds for each investor to on-chain investor accounts; minting blockchain-based cash tokens to blockchain addresses for each of the investors; transferring the blockchain-based cash tokens from the investor blockchain addresses to the blockchain address for the fund manager; transferring the blockchain-based cash tokens from the investor blockchain address to the investor blockchain addresses; and redeeming the blockchain-based cash tokens into cash, wherein the blockchain-based cash tokens are burned as a result of the redemption.

### BACKGROUND OF THE INVENTION

### 1. Field of the Invention

Embodiments generally relate to systems and methods for issuance and use of private equity tokens.

### 2. Description of the Related Art

Capital calls issued by private equity funds are often settled using a combination of traditional banking rails and a transfer agent ledger. These systems and records are reconciled amongst fund managers, fund administrators and fund distributors, thereby creating pain points and manual work.

### SUMMARY OF THE INVENTION

Systems and methods for issuance and use of private equity tokens are disclosed. According to an embodiment, a method may include: (1) receiving, by a fund administrator, capital needs from a fund manager; (2) accessing, by the fund administrator, an investor register on a digital assets blockchain and retrieving, for each investor, an amount committed, an amount called, an amount unfunded, and an amount distributed; (3) establishing, by the fund administrator, investor level capital call details for each investor based on the amount committed, the amounts called, the amounts unfunded, and the amounts distributed; (4) minting, by the fund administrator or other service provider, a total fund token balance to a blockchain address for the fund manager on the digital assets blockchain; (5) enriching, by a fund distribution/servicing application, the investor level capital call details to include fields/details that are specific to a distributor; (6) sharing, by the fund distribution/servicing application, the enriched investor level capital call details with the distributor; (7) moving, by the distributor, funds for each investor to on-chain investor accounts; (8) minting, by the distributor or other service provider, blockchain-based cash tokens to blockchain addresses on the digital assets blockchain for each of the investors; (9) transferring, by a digital assets blockchain, the blockchain-based cash tokens from the blockchain address for each of the investors to the blockchain address for the fund manager; (10) transferring, by the digital assets blockchain, the blockchain-based cash tokens from the investor blockchain address to the blockchain address for each of the investors; and (11) redeeming, by the fund administrator or other service provider, the blockchain-based cash tokens into cash, wherein the blockchain-based cash tokens are burned as a result of the redemption.

In one embodiment, the method may also include: sharing, by the fund administrator, the investor level capital call details with the fund distribution/servicing application.

In one embodiment, the investor level capital call details for each investor are based, pro rata, on the amounts committed, wherein the capital call details for each inventor cannot exceed the amount unfunded.

In one embodiment, the capital call details comprise an amount of cash to be sent for investments, expenses, and/or fees.

In one embodiment, the fields/details that are specific to the distributor comprise investor account numbers, identifiers for a distributor system, investor account attributes, and/or investor account attributes.

In one embodiment, the method may also include: notifying, by the distributor, one or more investors of the capital call.

According to another embodiment, a method may include: (1) receiving, by a fund administrator, distribution details for capital distribution from a fund manager, wherein the distribution details identify an amount to distribute to investors, an identification of investments that created the amount, expenses, and/or fees; (2) accessing, by the fund administrator, an investor register on a digital assets blockchain and retrieving, for each investor, an amount committed, an amount called, an amount unfunded, and an amount distributed; (3) creating, by the fund administrator and for each investor, investor level capital distribution details for the amount to distribute based on the identification of investments that created the amount, the fees, the amount committed, the amounts called, the amounts unfunded, and the amounts distributed; (4) enriching, by a fund distribution/servicing application, the investor level capital distribution details to include fields/details that are specific to a distributor; (5) sharing, by the fund distribution/servicing application, the enriched investor level capital distribution details with the distributor; (6) providing, by the distributor or other service provider, the enriched investor level capital distribution details into its accounting platform, wherein the accounting platform updates investment balances for each investor based on the enriched investor level capital distribution details; (7) minting, by the distributor, blockchain-based cash tokens to a blockchain addresses on the digital assets blockchain for the fund manager; (8) transferring, by the digital assets blockchain, the blockchain-based cash tokens from the investor blockchain address to the blockchain address for each of the investors; (9) burning, by the fund distribution/servicing application or other service provider, a corresponding fund unit balance for the blockchain-based cash tokens; and (10) redeeming, by the distributor, the blockchain-based cash tokens for the investors.

In one embodiment, the method may also include: sharing, by the fund administrator, the distribution details with the fund distribution/servicing application.

In one embodiment, the distribution details comprise account numbers, identifiers for the distributor system, and account attributes.

According to another embodiment, a method may include: (1) receiving, by a fund administrator, valuation source data for a fund from a fund manager, with a fund administrator, wherein the valuation source data comprises valuation reports, appraisals, analysis on comparable companies sold, expenses, and/or invoices; (2) calculating, by the fund administrator, a net asset valuation for the fund based on the valuation source data; (3) allocating, by the fund administrator, an amount for the net asset valuation to each of a plurality of investors according to each investor's investment; (4) accessing, by the fund administrator, an investor register on a digital assets blockchain and retrieving, for each investor, an amount committed, an amount called, an amount unfunded, and an amount distributed; (5) creating, by the fund administrator, investor statements for investor level reporting details; (6) sharing, by the fund administrator, the investor level reporting details with a fund distribution/servicing application; (7) enriching, by the fund distribution/servicing application, the investor level reporting details with distributor specific fields/details; (8) uploading, by the distributor, the enriched investor level reporting details into its accounting platform; and (9) notifying, by the accounting platform, the investors of investor statements.

In one embodiment, the method may also include: creating, by the fund administrator, investor statements for investor level reporting.

In one embodiment, the investor level reporting details comprise account numbers, identifiers for the distributor system, and account attributes.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for issuance and use of private equity tokens according to an embodiment.

FIG. 2 depicts a method for issuance and use of private equity tokens according to an embodiment.

FIG. 3 depicts a method for distribution of private equity tokens according to an embodiment.

FIG. 4 depicts a method for reporting information for private equity tokens according to an embodiment.

FIG. 5 depicts an exemplary computing system for implementing aspects of the present disclosure.

### DETAILED DESCRIPTION OF PREFERRED EMBODIMENTS

Embodiments are directed to systems and methods for issuance and use of private equity tokens.

Tokenization enables capital calls and distributions to be processed using on-chain cash being traded for an on-chain representation of an investment in a private equity fund. By doing this, the number of reconciliations is eliminated and/or reduced, and cash can be provided to a fund manager without a wire. Enabling this efficiency could also unlock new and innovative use cases for private equity fund tokens including automating the entire capital call process.

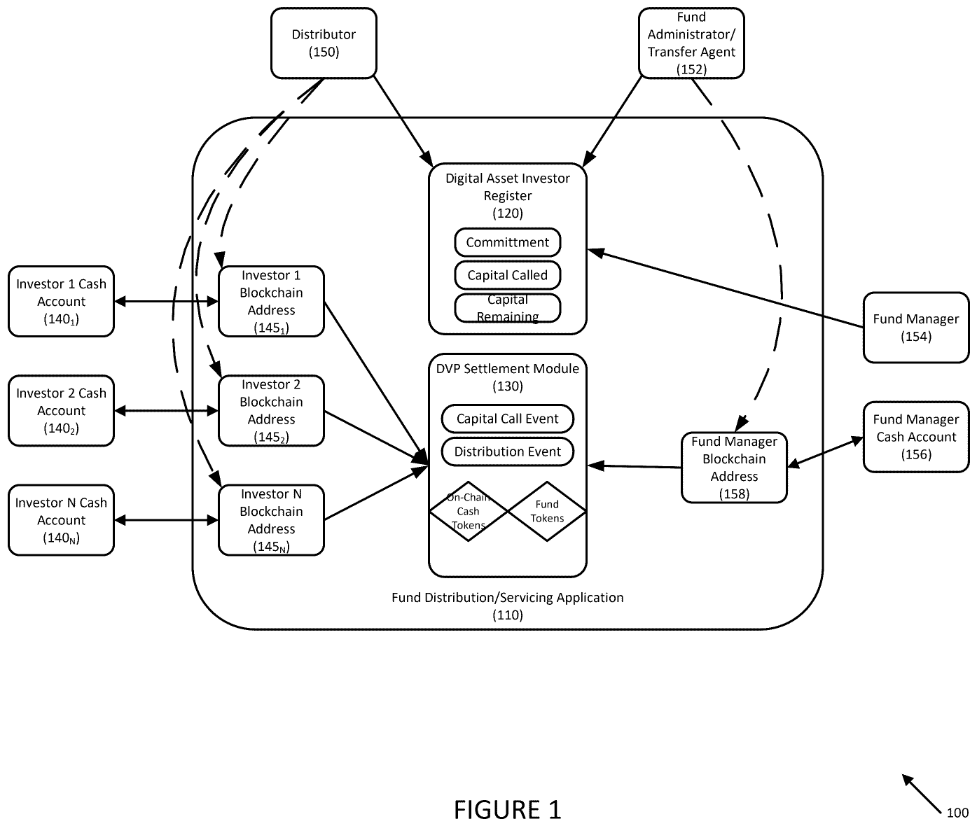

Referring to FIG. 1, a system for issuance and use of private equity tokens is disclosed according to an embodiment. Specifically, FIG. 1 depicts both the system for a shared, real-time view of the investor register and related activity, as well as the transactions that enable the issuance, use and burning of private equity fund tokens.

System 100 may include fund distribution/servicing application 110, which may include digital asset investor register 120 and delivery versus payment (DVP) settlement module 130. Fund distribution/servicing application 110 may be hosted on a distributed ledger network.

Fund distribution/servicing application 110 may further include blockchain addresses, such as investor 1 blockchain address 1451, investor 2 blockchain address 1452, investor N blockchain address 145N, and fund manager blockchain address 158. Each blockchain address may be associated with a cash account, such as investor 1 cash account 1401, investor 2 cash account 1402, investor N cash account 140N, and fund manager cash account 156.

Digital asset investor register 120 may include data elements, such as a commitment data element, a capital called data element, and a capital remaining data element, and delivery versus payment settlement module 130 may include capital call events, distribution events, on-chain cash tokens, and fund tokens.

In one embodiment, capital call events and distribution events may be messages that initiate the movement of cash. The movement of cash then triggers the minting of fund tokens and delivery versus payment settlement.

The commitment data element, a capital called data element, and a capital remaining data element, may be maintained within a token for a fund. System 100 may also include distributor 150, fund administrator/transfer agent 152, and fund manager 154.

For example, distributor 150 may market and sell investment products to end investors. Distributor 150 may source and due diligence appropriate investment offerings, and make them available, to their clients.

Distributor(s) 150 may move dollars on behalf of their investors onto the fund distribution/servicing application 110 to affect the trade of on chain cash for fund tokens.

Fund administrator/transfer agent 152 may perform administrative tasks, such as reporting, statement distribution, initiating minting of tokens, and maintaining an official investor register or list of investors and their respective holdings in the fund, for fund manager 154.

Fund manager 154 may deploy the dollars invested into the fund in a stated investment strategy with the goal of generating profits for investors.

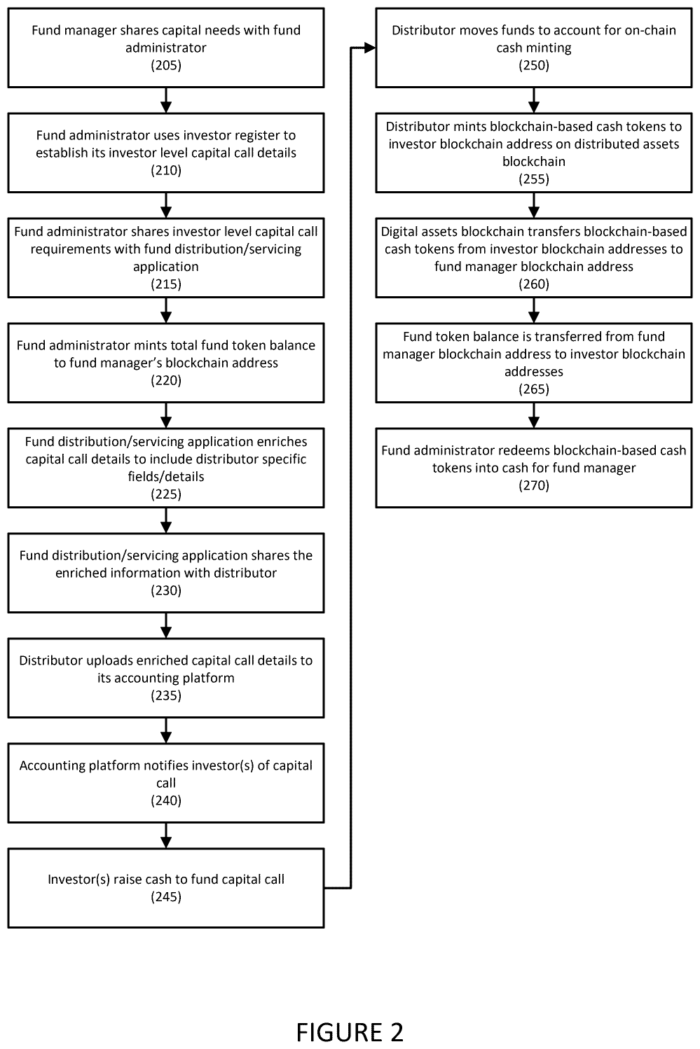

Referring to FIG. 2, a method for issuance and use of private equity tokens is disclosed according to an embodiment.

In step 205, a fund manager may share its capital needs with a fund administrator. For example, the fund manager may assess the capital needs of the fund and may provide that information to the fund administrator.

In step 210, the fund administrator may access and use an investor register to establish its investor level capital call details. This may include, for example, the amount of cash to be sent for investments, expenses and fees with all of the requisite details.

The register may be maintained in a fund distribution/servicing application on a digital assets blockchain. This may include, for example, the amounts committed, called, unfunded, and distributed.

In one embodiment, the capital call details for each investor may be based on a pro-rata breakdown by commitment amount while also considering unfunded commitments (they cannot exceed this number).

In step 215, the fund administrator may share the investor level capital call requirements with the fund distribution/servicing application.

In step 220, the fund administrator or another suitable service provider may mint a total fund token balance to the fund manager's blockchain address. This step may also occur later in the process and directly to each investor blockchain address without the need to first be minted to the fund managers blockchain address.

In step 225, the fund distribution/servicing application may enrich the capital call details to include distributor specific fields/details. Examples of capital call details may include account numbers, identifiers for the distributor system, account location and attributes, system of record, etc. In one embodiment, the fund distribution/servicing application may perform the enriching, by consuming information related to capital events for a set of investors and combining it with data and attributes required by the distributor. The output of the enrichment may be a file or API that can be easily/automatically consumed by the distributor's system of record.

In step 230, the fund distribution/servicing application may share the enriched information with a distributor, and in step 235, the distributor may upload enriched capital call details into its accounting platform.

In step 240, the distributor may notify one or more investors of the capital call.

In step 245, the investor(s) may raise cash to fund the capital call.

In step 250, the distributor may move funds from the investor account(s) to an account that allows for on-chain cash to be minted. In embodiments, the investors may ensure that the relevant cash account is sufficient to meet the capital call, then distributor moves cash on the investors' behalf. The funds may be moved, for example, as on-chain cash, or via another cash account first to enable the on-chain minting.

In step 255, for each investor, the distributor or another suitable service provider may mint blockchain-based cash tokens to the investor blockchain address on the distributed assets blockchain. In one embodiment, this may be an automated process.

In step 255, the digital assets blockchain may transfer the blockchain-based cash tokens from investor blockchain addresses to the fund manager blockchain address. This transfer may initiate the transfer of fund tokens in the right amount to the right address.

In step 265, the fund token balance may be transferred from the fund manager blockchain address to investor blockchain address(es). In one embodiment, this may involve direct minting of fund tokens to the investor blockchain addresses as opposed to minting to the fund manager's blockchain address first and then transferring.

Steps 260 and 265 may be performed substantially simultaneously as part of a delivery versus payment process.

In step 270, the fund administrator or another suitable service provider may redeem the blockchain-based cash tokens into cash for fund manager. In one embodiment, the redemption may include burning cash tokens.

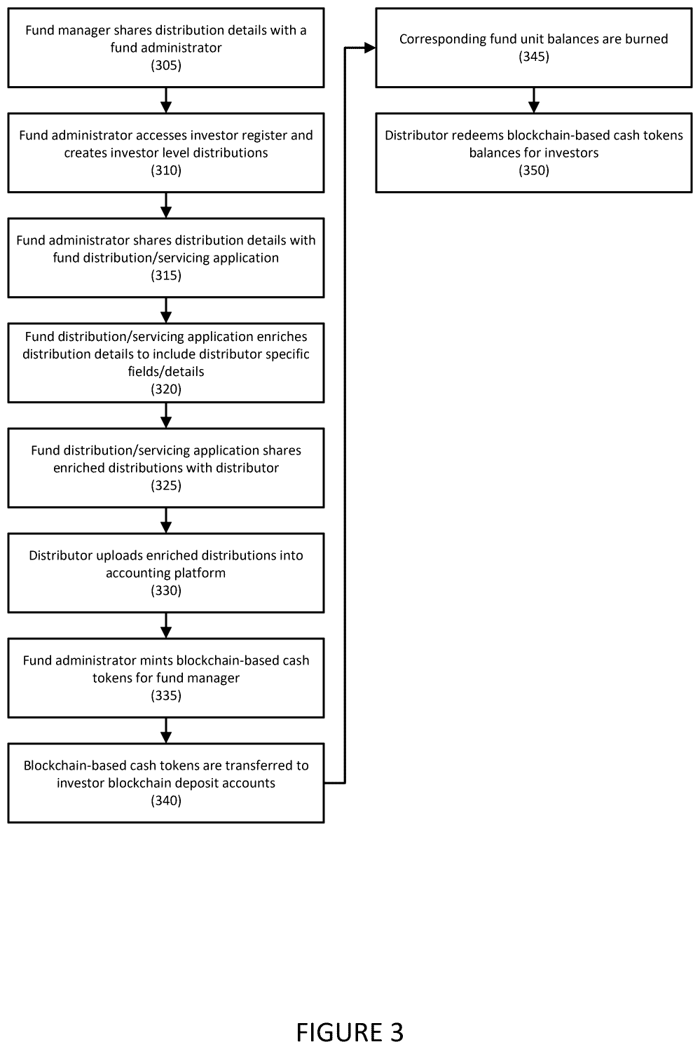

Referring to FIG. 3, a method for distribution of private equity tokens is disclosed according to an embodiment.

In step 305, a fund manager may share distribution details with a fund administrator. For example, the fund manager may inform the fund administrator how much cash the fund administrator has to return to investors, and which investments created this cash. The fund manager may also share fund level details (e.g., fees, expenses, etc.).

In step 310, the fund administrator may access an investor register and may create investor level distributions. For example, the fund administrator may access the on-chain information (e.g., commitments, called capital, unfunded and distributed capital, etc.) to calculate the investor level balances.

In step 315, the fund administrator may share the distribution details with the fund distribution/servicing application.

In step 320, the fund distribution/servicing application may enrich the distribution details to include distributor specific fields/details. Examples of distribution details may include account numbers, identifiers for the distributor system, account locations, account attributes, systems of record, etc.

In step 325, the fund distribution/servicing application may share the enriched distributions with the distributor.

In step 330, the distributor may upload the enriched distributions into its accounting platform, which may make the relevant update in the investors' investment balances.

In step 335, the fund administrator may mint blockchain-based cash tokens for the fund manager.

In step 340, the blockchain-based cash tokens may be transferred to the investor(s) blockchain deposit account. This may be part of a delivery versus payment process.

In step 345, the fund distribution/servicing application may burn the corresponding fund unit balance. In one embodiment, the fund distribution/servicing application may perform the calculations and actions for the burn. In one embodiment, the burn may be an automated burn from the fund administrator using the fund administrator's keys.

In step 350, the distributor may redeem the blockchain-based cash tokens balances for the investor(s).

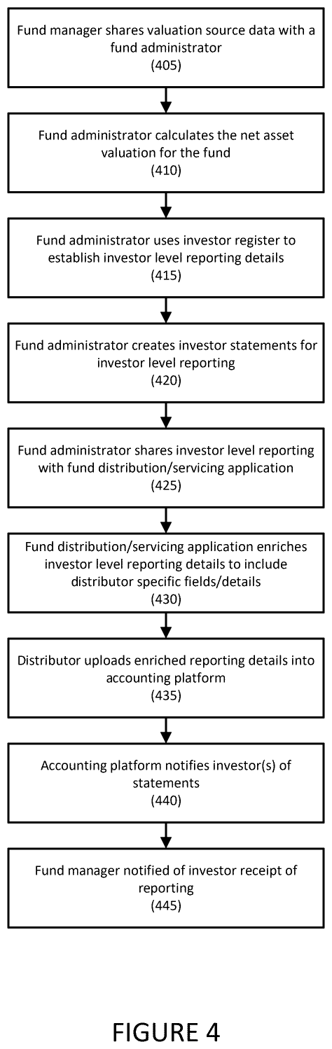

Referring to FIG. 4, a method for reporting information for private equity tokens is disclosed according to an embodiment. In embodiments, the information reported may include investor balances, summary activity, and performance information.

In step 405, a fund manager may share valuation source data with a fund administrator. For example, the fund manager may share valuation reports, appraisals, analysis on comparable companies sold, expenses, invoices, etc.

In step 410, the fund administrator may calculate a net asset valuation for the fund. For example, the fund administrator may calculate a sum of the parts for each asset, may subtract any liabilities, and allocate the amount according to each investor's investment.

In step 415, the fund administrator may access and use the investor register to establish investor level reporting details. For example, the fund administrator may retrieve the investors' commitment amounts, amounts called, amount distributed, etc. and may use this information to establish valuations and performance reporting.

In step 420, the fund administrator may create investor statements for investor level reporting.

In step 425, the fund administrator may share the investor level reporting with the fund distribution/servicing application, and, in step 430, the fund distribution/servicing application may enrich the investor level reporting details to include distributor specific fields/details. Examples of details may include account numbers, account attributes, systems of record, etc.

In step 435, the distributor may upload the enriched reporting details into its accounting platform, and in step 440, the accounting platform may notify the investor(s) of statements. For example, individual investor statements may be provided to the distributor in a conventional manner and may be posted to, for example, the distributor's online portal for the investors to address. The enriched reporting details, which may include aggregated investor information, may be used by the distributor to update its accounting systems.

In step 445, the fund manager may be notified of the receipt of the reporting by the investors.

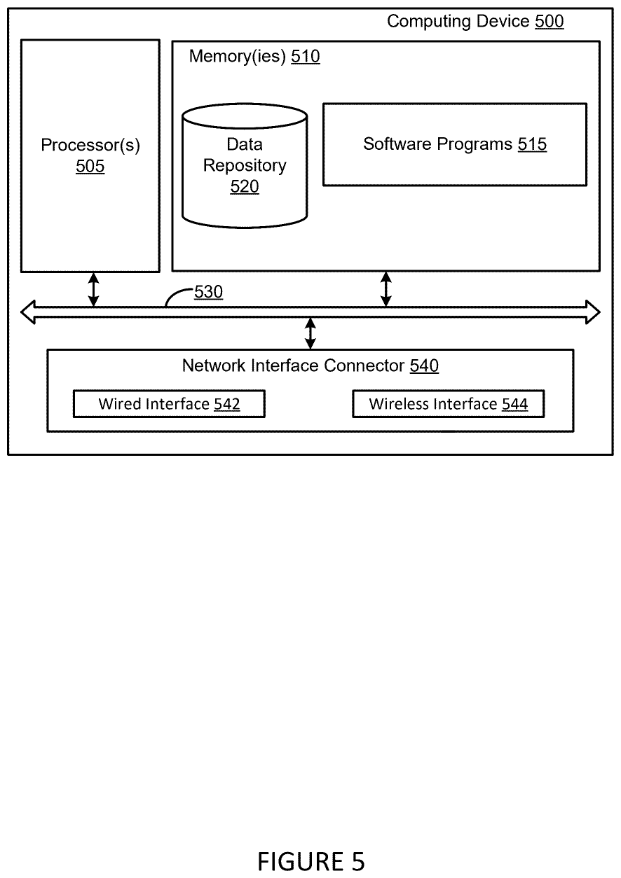

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a fund administrator, capital needs from a fund manager;
accessing, by the fund administrator, an investor register on a digital assets blockchain and retrieving, for each investor, an amount committed, an amount called, an amount unfunded, and an amount distributed;
establishing, by the fund administrator, investor level capital call details for each investor based on the amount committed, the amounts called, the amounts unfunded, and the amounts distributed;
minting, by the fund administrator or other service provider, a total fund token balance to a blockchain address for the fund manager on the digital assets blockchain;
enriching, by a fund distribution/servicing application, the investor level capital call details to include fields/details that are specific to a distributor;
sharing, by the fund distribution/servicing application, the enriched investor level capital call details with the distributor;
moving, by the distributor, funds for each investor to on-chain investor accounts;
minting, by the distributor or other service provider, blockchain-based cash tokens to blockchain addresses on the digital assets blockchain for each of the investors;
transferring, by a digital assets blockchain, the blockchain-based cash tokens from the blockchain address for each of the investors to the blockchain address for the fund manager;
transferring, by the digital assets blockchain, the blockchain-based cash tokens from the investor blockchain address to the blockchain address for each of the investors; and
redeeming, by the fund administrator or other service provider, the blockchain-based cash tokens into cash, wherein the blockchain-based cash tokens are burned as a result of the redemption.

2. The method of claim 1, further comprising:
sharing, by the fund administrator, the investor level capital call details with the fund distribution/servicing application.

3. The method of claim 1, wherein the investor level capital call details for each investor are based, pro rata, on the amounts committed, wherein the capital call details for each inventor cannot exceed the amount unfunded.

4. The method of claim 1, wherein the capital call details comprise an amount of cash to be sent for investments, expenses, and/or fees.

5. The method of claim 1, wherein the fields/details that are specific to the distributor comprise investor account numbers, identifiers for a distributor system, investor account attributes, and/or investor account attributes.

6. The method of claim 1, further comprising:
notifying, by the distributor, one or more investors of the capital call.

7. A method, comprising:
receiving, by a fund administrator, distribution details for capital distribution from a fund manager, wherein the distribution details identify an amount to distribute to investors, an identification of investments that created the amount, expenses, and/or fees;
accessing, by the fund administrator, an investor register on a digital assets blockchain and retrieving, for each investor, an amount committed, an amount called, an amount unfunded, and an amount distributed;
creating, by the fund administrator and for each investor, investor level capital distribution details for the amount to distribute based on the identification of investments that created the amount, the fees, the amount committed, the amounts called, the amounts unfunded, and the amounts distributed;
enriching, by a fund distribution/servicing application, the investor level capital distribution details to include fields/details that are specific to a distributor;
sharing, by the fund distribution/servicing application, the enriched investor level capital distribution details with the distributor;
providing, by the distributor or other service provider, the enriched investor level capital distribution details into its accounting platform, wherein the accounting platform updates investment balances for each investor based on the enriched investor level capital distribution details;
minting, by the distributor, blockchain-based cash tokens to a blockchain addresses on the digital assets blockchain for the fund manager;
transferring, by the digital assets blockchain, the blockchain-based cash tokens from the investor blockchain address to the blockchain address for each of the investors;
burning, by the fund distribution/servicing application or other service provider, a corresponding fund unit balance for the blockchain-based cash tokens; and
redeeming, by the distributor, the blockchain-based cash tokens for the investors.

8. The method of claim 7, further comprising:
sharing, by the fund administrator, the distribution details with the fund distribution/servicing application.

9. The method of claim 7, wherein the distribution details further comprise account attributes and identifiers for a distributor system.

10. A method, comprising:
receiving, by a fund administrator, valuation source data for a fund from a fund manager, with a fund administrator, wherein the valuation source data comprises valuation reports, appraisals, analysis on comparable companies sold, expenses, and/or invoices;
calculating, by the fund administrator, a net asset valuation for the fund based on the valuation source data;
allocating, by the fund administrator, an amount for the net asset valuation to each of a plurality of investors according to each investor's investment;
accessing, by the fund administrator, an investor register on a digital assets blockchain and retrieving, for each investor, an amount committed, an amount called, an amount unfunded, and an amount distributed;
creating, by the fund administrator, investor statements for investor level reporting details;
sharing, by the fund administrator, the investor level reporting details with a fund distribution/servicing application;
enriching, by the fund distribution/servicing application, the investor level reporting details with distributor specific fields/details;
uploading, by the distributor, the enriched investor level reporting details into its accounting platform; and
notifying, by the accounting platform, the investors of investor statements.

11. The method of claim 10, further comprising:
creating, by the fund administrator, investor statements for investor level reporting.

12. The method of claim 10, wherein the investor level reporting details comprise account attributes and identifiers for a distributor system.
